(19) United States
(12) Patent Application Publication
(10) Pub. No.: US 2016/0151978 A1
(43) Pub. Date: Jun. 2, 2016

(54) THREE-DIMENSIONAL PRINTER WITH ADJUSTMENT FUNCTION AND OPERATION METHOD THEREOF

(71) Applicant: Etron Technology, Inc., Hsinchu (TW)

(72) Inventor: Wen-Kuo Lin, Taipei City (TW)

(21) Appl. No.: 14/940,085

(22) Filed: Nov. 12, 2015

Related U.S. Application Data
(60) Provisional application No. 62/078,422, filed on Nov. 12, 2014.

(51) Int. Cl. B29C 67/00

(52) U.S. Cl. CPC B29C 67/0088; B29C 67/0055; B29K 2105/0058

(57) ABSTRACT

A three-dimensional printer with adjustment function includes a print head, a platform, a movement control device, and an adjustment device. The movement control device is coupled to the platform, wherein the movement control device moves the platform to make a three-dimensional relative motion existing between the platform and the print head during a printing process of the print head printing an object on the platform. The adjustment device is used for controlling the print head or the movement control device to make a track of the three-dimensional relative motion meet a right relative motion track during the printing process, or make the three-dimensional printer terminate the printing process.

### CROSS REFERENCE TO RELATED APPLICATIONS

This application claims the benefit of U.S. Provisional Application No. 62/078,422, filed on Nov. 12, 2014 and entitled “3D printer with monitor function,” the contents of which are incorporated herein by reference.

### BACKGROUND OF THE INVENTION

1. Field of the Invention

The present invention relates to a three-dimensional (3D) printer with adjustment function and an operation method thereof, and particularly to a 3D printer and an operation method thereof that can make a track of a 3D relative motion existing between a print head and a platform of the 3D printer meet a right relative motion track during a printing process of the print head printing a 3D object, or make the 3D printer terminate the printing process.

2. Description of the Prior Art

A three-dimensional (3D) printing is a printing process of a 3D printer printing a 3D object, wherein the 3D printer makes a print head successively inject or generate printing material layers forming the 3D object layer by layer on a platform by controlling a 3D relative motion existing between the print head and the platform. In the prior art, the 3D printer can utilize a movement control device coupled to the platform to adjust the 3D relative motion exiting between the platform and the print head during the printing process, the 3D object can be finished after the printing material layers are printed layer by layer completely.

However, the 3D printer provided by the prior art has a slower printing speed to severely limit production of the 3D object. During the printing process of the 3D printer printing the 3D object, if there is any mistake happens (e.g. shift or dislocation of the movement control device, unwanted movement or pull of the semi-finished 3D object on the platform, and so on), such mistake will make the semi-finished 3D object be destroyed and the above mentioned time-consuming printing process will be resumed. Therefore, the 3D printer provided by the prior art is not a good choice for a user.

### SUMMARY OF THE INVENTION

An embodiment of the present invention provides a three-dimensional (3D) printer with adjustment function. The 3D printer includes a print head, a platform, a movement control device, and an adjustment device. The movement control device is coupled to the platform, wherein the movement control device moves the platform to make a 3D relative motion existing between the platform and the print head during a printing process of the print head printing a 3D object on the platform. The adjustment device is used for controlling the print head or the movement control device to make a track of the 3D relative motion meet a right relative motion track during the printing process, or make the 3D printer terminate the printing process.

Another embodiment of the present invention provides a 3D printer. The 3D printer includes a print head, a platform, a movement control device, and an adjustment device. The movement control device is coupled to the platform or the print head, wherein the movement control device controls to generate a track of a relative motion between the platform and the print head to make the print head print a 3D object on the platform. The adjustment device compares the track of the relative motion with a default print track to optionally adjust the track of the relative motion, or make the 3D printer terminate to print the 3D object.

Another embodiment of the present invention provides an operation method of a 3D printer with adjustment function, wherein the 3D printer includes a print head, a platform, a movement control device, and an adjustment device adjustment device. The operation method includes the print head printing a 3D object on the platform; the movement control device moving the platform to make a 3D relative motion existing between the platform and the print head during a printing process of the print head printing the 3D object; and the adjustment device controlling the print head or the movement control device to make a track of the 3D relative motion meet a right relative motion track during the printing process, or make the 3D printer terminate the printing process.

The present invention provides a 3D printer with adjustment function and an operation method thereof. The 3D printer and the operation method utilize an adjustment device or a processing device to compare a track of a 3D relative motion between a print head and a platform with a right relative motion track during a printing process of the print head printing a 3D object, wherein when an offset between the track of the 3D relative motion and the right relative motion track is less than a threshold, the adjustment device controls the print head or a movement control device to make the track of the 3D relative motion meet the right relative motion track during the printing process, and when the offset between the track of the 3D relative motion and the right relative motion track is greater than the threshold, the adjustment device controls the print head or the movement control device to make the 3D printer terminate the printing process. Therefore, compared to the prior art, because the 3D printer has the adjustment function, the present invention can real time utilize the adjustment device to control the print head or the movement control device to make the track of the 3D relative motion meet the right relative motion track during the printing process when there is any mistake happens (e.g. shift or dislocation of the movement control device, unwanted movement or pull of the semi-finished 3D object on the platform, and so on). Therefore, the present invention can increase a printing speed of the 3D printer and decrease time consumption during the printing process.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a three-dimensional printer with adjustment function according to a first embodiment of the present invention.

FIG. 2 is a diagram illustrating a 3D printer with adjustment function according to a second embodiment of the present invention.

FIG. 3 is a diagram illustrating the 3D object being located in an image capture range of the 3D camera module.

FIG. 4 is a diagram illustrating the first image sensing unit and the second image sensing unit being swung to make the 3D object be always located at an intersection of a line determined by a center of the first image sensing unit and the 3D object and a line determined by a center of the second image sensing unit and the 3D object when a distance between the first image sensing unit and the 3D object is varied with movement of the 3D object.

FIG. 5 is a diagram illustrating a baseline between the first image sensing unit and the second image sensing unit being varied with a distance existing between the first image sensing unit and the 3D object according to another embodiment of the present invention.

FIG. 6 is a diagram illustrating a 3D camera module according to another embodiment of the present invention.

FIG. 7 is a diagram illustrating relationships between an emitting angle of a light source, the distance D1 existing between the first image sensing unit of the 3D camera module and the 3D object, and a ratio of a size of a predetermined light pattern formed on a surface of the 3D object to a size of a predetermined light pattern emitted by the light source.

FIG. 8 is a diagram illustrating ratios determined by predetermined light patterns formed on the surface of the 3D object and the size of the predetermined light pattern emitted by the light source being varied with different emitting angles of the light source when the distance exists between the first image sensing unit of the 3D camera module and the 3D object, and the light source has the different emitting angles.

FIG. 9 is a diagram illustrating ratios determined by predetermined light patterns formed on the surface of the 3D object and the size of the predetermined light pattern emitted by the light source being varied with different distances existing between the first image sensing unit of the 3D camera module and the 3D object when different distances exist between the first image sensing unit of the 3D camera module and the 3D object and the light source has the emitting angle.

FIG. 10 is a diagram illustrating a 3D printer with adjustment function according to a third embodiment of the present invention.

FIG. 11 is a diagram illustrating a 3D printer with adjustment function according to a fourth embodiment of the present invention.

FIG. 12 is a flowchart illustrating an operation method of a 3D printer with adjustment function according to a fifth embodiment of the present invention.

FIG. 13 is a flowchart illustrating an operation method of a 3D printer with adjustment function according to a sixth embodiment of the present invention.

FIGS. 14A, 14B are flowcharts illustrating an operation method of a 3D printer with adjustment function according to a seventh embodiment of the present invention.

### DETAILED DESCRIPTION

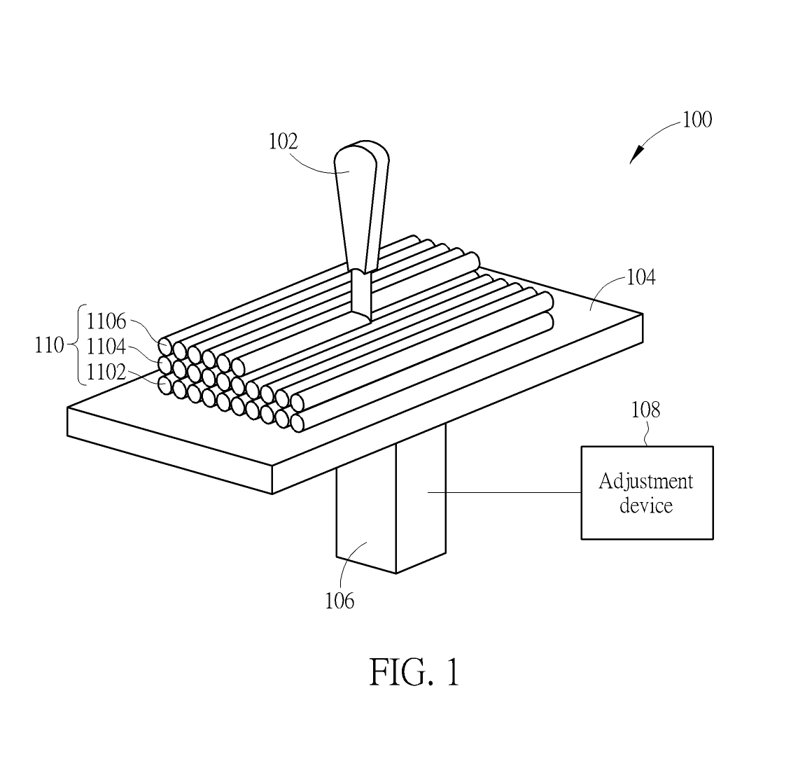

Please refer to FIG. 1. FIG. 1 is a diagram illustrating a three-dimensional (3D) printer 100 with adjustment function according to a first embodiment of the present invention. As shown in FIG. 1, the 3D printer 100 includes a print head 102, a platform 104, a movement control device 106, and an adjustment device 108. Because the movement control device 106 can move the platform 104 to make a 3D relative motion existing between the print head 102 and the platform 104 during a printing process of the print head 102 printing a 3D object 110 on the platform 104, the print head 102 can successively inject or generate printing material layers 1102, 1104, 1106 forming the 3D object 110 layer by layer on the platform 104 during the printing process, wherein the 3D relative motion can be represented by a 3D Cartesian coordinate system or a 3D polar coordinate system. As shown in FIG. 1, the adjustment device 108 can be used for comparing a track of the3D relative motion with a right relative motion track (that is, a default print track) to control the movement control device 106 to make the track of the 3D relative motion meet the right relative motion track during the printing process, wherein the right relative motion track is stored in the adjustment device 108, or make the 3D printer 100 terminate the printing process, wherein when an offset between the track of the 3D relative motion and the right relative motion track is less than a threshold, the adjustment device 108 controls the movement control device 106 to modify the track of the 3D relative motion to make the track of the 3D relative motion meet the right relative motion track during the printing process. For example, as shown in FIG. 1, if an error happens when the print head 102 just finishes the printing material layer 1104 and the movement control device 106 moves the platform 104 to a predetermined position to make the print head 102 prepare to inject or generate the printing material layers 1106 (e.g. the movement control device 106 should move the platform 104 toward a Z axis 1 mm away from a current position of the platform 104, but the movement control device 106 only moves the platform 104 toward the Z axis 0.6 mm away from the current position of the platform 104), meanwhile, the adjustment device 108 can control the movement control device 106 to modify the track of the 3D relative motion to make the track of the 3D relative motion meet the right relative motion track during the printing process because the offset (that is, 0.4 mm) between the track of the 3D relative motion and the right relative motion track is less than the threshold (e.g. 2 mm). If the movement control device 106 should move the platform 104 toward the Z axis 1 mm away from the current position of the platform 104, but the movement control device 106 moves the platform 104 toward the Z axis 4 mm way from the current position of the platform 104, meanwhile, the adjustment device 108 can make the 3D printer 100 terminate the printing process because the offset (that is, 3 mm) between the track of the 3D relative motion and the right relative motion track is greater than the threshold (e.g. 2 mm). In addition, in another embodiment of the present invention, the adjustment device 108 can control the print head 102 (meanwhile, the adjustment device 108 is coupled to the print head 102), or simultaneously control the print head 102 and the movement control device 106 (meanwhile, the adjustment device 108 is simultaneously coupled to the print head 102 and the movement control device 106) to modify the track of the 3D relative motion to make the track of the 3D relative motion meet the right relative motion track during the printing process, or make the 3D printer 100 terminate the printing process. In addition, in another embodiment of the present invention, the movement control device 106 is coupled to the platform 104 and the print head 102, so the adjustment device 108 can simultaneously control the platform 104 and the print head 102 through the movement control device 106 to modify the track of the 3D relative motion to make the track of the 3D relative motion meet the right relative motion track during the printing process, or make the 3D printer 100 terminate the printing process.

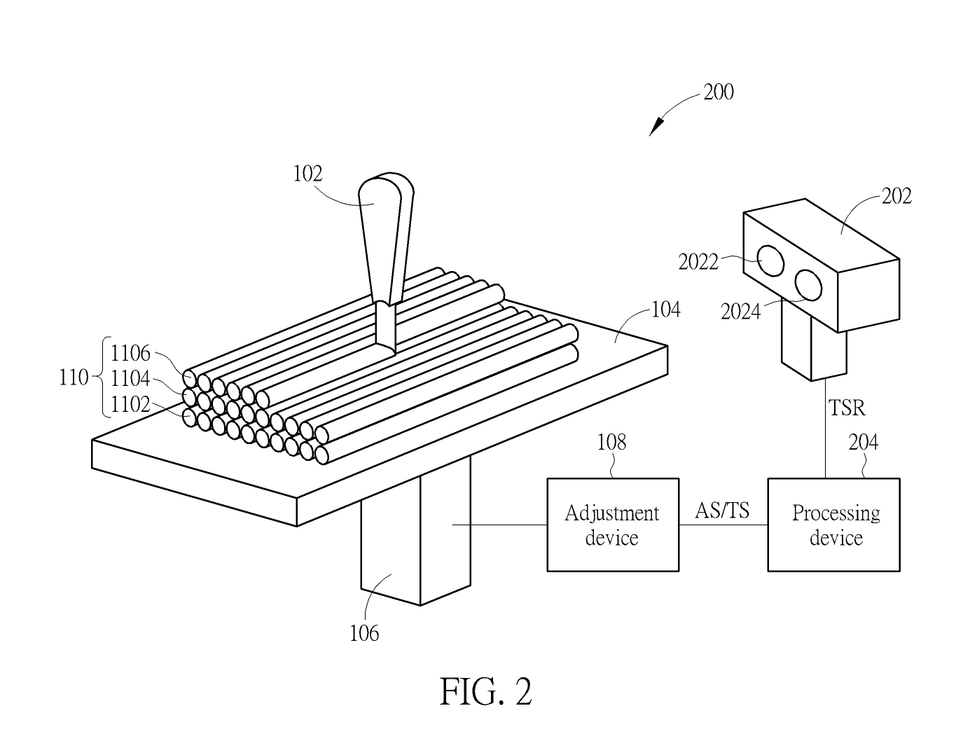

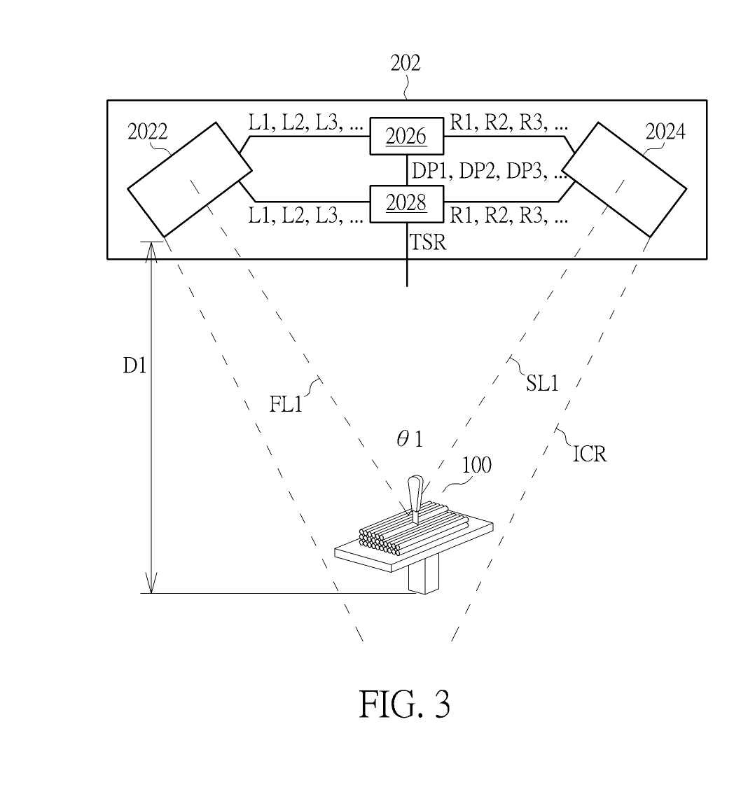

Please refer to FIG. 2. FIG. 2 is a diagram illustrating a 3D printer 200 with adjustment function according to a second embodiment of the present invention. As shown in FIG. 2, a difference between the 3D printer 200 and the 3D printer 100 is that the 3D printer 200 further includes a 3D camera module 202 and a processing device 204. Please refer to FIG. 3. FIG. 3 is a diagram illustrating the 3D object 110 being located in an image capture range ICR of the 3D camera module 202. As shown in FIG. 3, the 3D camera module 202 includes a first image sensing unit 2022, a second image sensing unit 2024, a depth map generation unit 2026, and an image processing unit 2028, wherein the first image sensing unit 2022 and the second image sensing unit 2024 are charge-coupled device (CCD) sensing units or contact image sensors. In addition, the present invention is not limited to the 3D camera module 202 only including the first image sensing unit 2022 and the second image sensing unit 2024. That is to say, the 3D camera module 202 can include more than two image sensing units. When the 3D object 110 is located in the image capture range ICR of the 3D camera module 202 (shown in FIG. 3), the first image sensing unit 2022 can capture a first image L1 including the 3D object 110 during the printing process, and second image sensing unit 2024 can also capture a second image R1 including the 3D object 110 during the printing process, wherein the first image L1 corresponds to the second image R1, the first image L1 and the second image R1 are RGB images or YUV images, and the first image L1 is a left image and the second image R1 is a right image. But, the present invention is not limited to the first image L1 and the second image R1 being RGB images or YUV images. That is to say, the first image L1 and the second image R1 can be other types of color images. As shown in FIG. 3, after the depth map generation unit 2026 receives the first image L1 and the second image R1, the depth map generation unit 2026 can process the first image L1 and the second image R1 together to generate a depth map DP1 corresponding to the 3D object 110 according to a first synchronization signal corresponding to the first image L1 and a second synchronization signal corresponding to the second image R1. That is to say, the depth map generation unit 2026 can generate the depth map DP1 corresponding to the 3D object 110 according to each scan line of the first image L1 and a corresponding scan line of the second image R1 in turn. In addition, during the printing process, when the first image sensing unit 2022 captures a plurality of first images L1, L2, L3, . . . including the 3D object 110, and the second image sensing unit 2024 captures a plurality of corresponding second images R1, R2, R3, . . . including the 3D object 110, the depth map generation unit 2026 can generate depth maps DP1, DP2, DP3, . . . corresponding to the 3D object 110 according to the above mentioned principles. Therefore, as shown in FIG. 3, after the depth map generation unit 2026 generates the depth maps DP1, DP2, DP3, . . . corresponding to the 3D object 110, the image processing unit 2028 can generate and output a 3D scan result TSR corresponding to the 3D object 110 according to the plurality of first images L1, L2, L3, . . . , the plurality of second images R1, R2, R3, . . . , and the plurality of depth maps DP1, DP2, DP3, . . . , wherein the 3D scan result TSR corresponding to the 3D object 110 includes information of the track of the 3D relative motion.

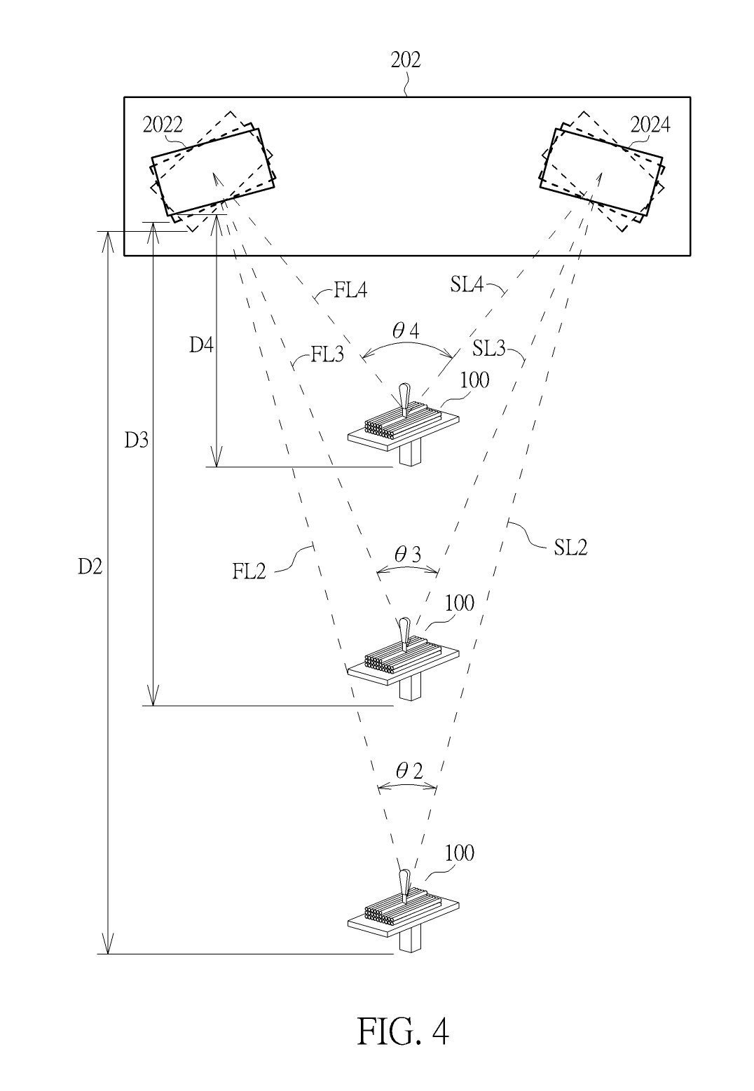

In addition, as shown in FIG. 3, when the first image sensing unit 2022 captures the first image L1, a distance D1 exists between the first image sensing unit 2022 of the 3D camera module 202 and the 3D object 110, wherein the distance D1 corresponds to the depth map DP1, and the distance D1 is varied with movement of the 3D object 110. As shown in FIG. 3, when the first image sensing unit 2022 captures the first image L1, the distance D1 exists between the first image sensing unit 2022 and the 3D object 110, an angle θ1 exists between a line FL1 determined by a center of the first image sensing unit 2022 and the 3D object 110 and a line SL1 determined by a center of the second image sensing unit 2024 and the 3D object 110, and the 3D object 110 is located at an intersection of the line FL1 and the line SL1. In addition, because when the 3D camera module 202 scans the 3D object 110, the 3D object 110 can be moved arbitrarily with the platform 104, a distance existing between the first image sensing unit 2022 of the 3D camera module 202 and the 3D object 110 can be varied with the movement of the 3D object 110. That is to say, when a distance existing between the first image sensing unit 2022 of the 3D camera module 202 and the 3D object 110 is varied with the movement of the 3D object 110, the first image sensing unit 2022 and the second image sensing unit 2024 can be swung to make the 3D object 110 be always located at an intersection of a line determined by the center of the first image sensing unit 2022 and the 3D object 110 and a line determined by the center of the second image sensing unit 2024 and the 3D object 110 (as shown in FIG. 4, wherein FIG. 4 only shows the first image sensing unit 2022 and the second image sensing unit 2024). As shown in FIG. 4, when a distance D2 exists between the first image sensing unit 2022 of the 3D camera module 202 and the 3D object 110, an angle θ2 exists between a line FL2 determined by the center of the first image sensing unit 2022 and the 3D object 110 and a line SL2 determined by the center of the second image sensing unit 2024 and the 3D object 110, wherein the distance D2 corresponds to a depth map DP2 generated by the depth map generation unit 2026; when a distance D3 exists between the first image sensing unit 2022 of the 3D camera module 202 and the 3D object 110, an angle θ3 exists between a line FL3 determined by the center of the first image sensing unit 2022 and the 3D object 110 and a line SL3 determined by the center of the second image sensing unit 2024 and the 3D object 110, wherein the distance D3 corresponds to a depth map DP3 generated by the depth map generation unit 2026; and when a distance D4 exists between the first image sensing unit 2022 of the 3D camera module 202 and the 3D object 110, an angle θ4 exists between a line

FL4 determined by the center of the first image sensing unit 2022 and the 3D object 110 and a line SL4 determined by the center of the second image sensing unit 2024 and the 3D object 110, wherein the distance D4 corresponds to a depth map DP4 generated by the depth map generation unit 2026. As shown in FIG. 4, because the first image sensing unit 2022 and the second image sensing unit 2024 can be swung, no matter how the 3D object 110 is moved with the platform 104, the 3D camera module 202 can always make the 3D object 110 be located at an intersection of a line determined by the center of the first image sensing unit 2022 and the 3D object 110 and a line determined by the center of the second image sensing unit 2024 and the 3D object 110. In addition, because the first image sensing unit 2022 and the second image sensing unit 2024 can be swung, compared to the prior art, the 3D scan result TSR generated by the 3D camera module 202 can have less errors.

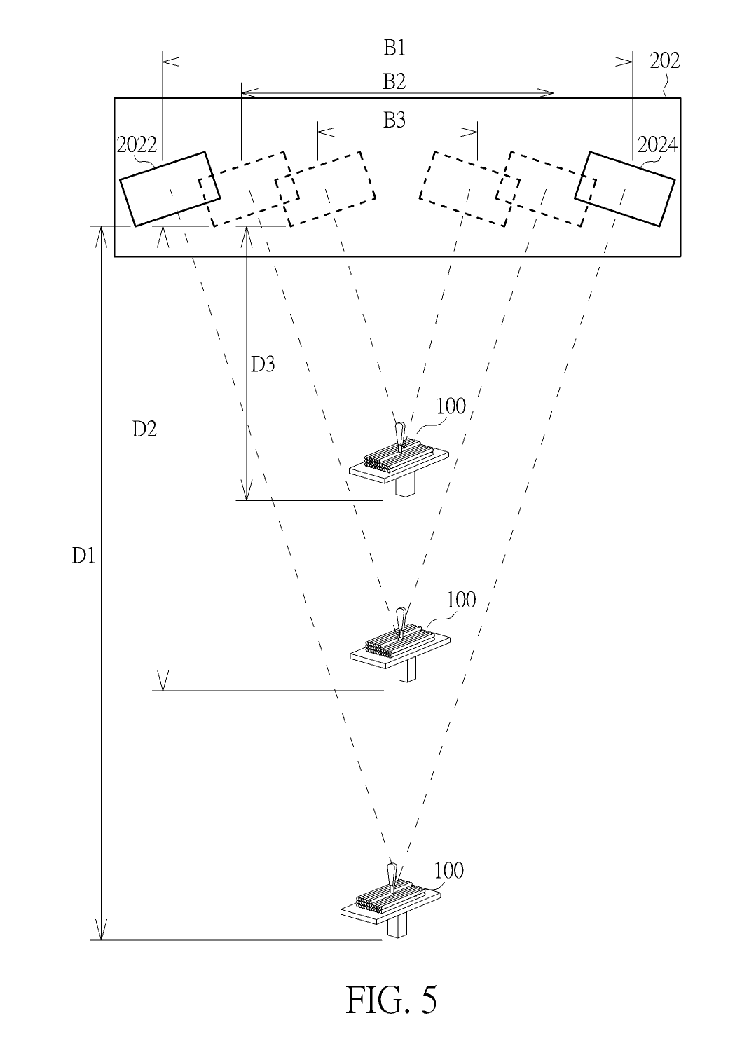

Please refer to FIG. 5. FIG. 5 is a diagram illustrating a baseline between the first image sensing unit 2022 and the second image sensing unit 2024 being varied with a distance existing between the first image sensing unit 2022 and the 3D object 110 according to another embodiment of the present invention, wherein FIG. 5 only shows the first image sensing unit 2022 and the second image sensing unit 2024. As shown in FIG. 5, when the distance D1 exists between the first image sensing unit 2022 of the 3D camera module 202 and the 3D object 110, a baseline B1 exists between the first image sensing unit 2022 and the second image sensing unit 2024; when the distance D2 exists between the first image sensing unit 2022 of the 3D camera module 202 and the 3D object 110, a baseline B2 exists between the first image sensing unit 2022 and the second image sensing unit 2024; and when the distance D3 exists between the first image sensing unit 2022 of the 3D camera module 202 and the 3D object 110, a baseline B3 exists between the first image sensing unit 2022 and the second image sensing unit 2024. As shown in FIG. 5, because a baseline existing between the first image sensing unit 2022 and the second image sensing unit 2024 can be varied with a distance existing between the first image sensing unit 2022 of the 3D camera module 202 and the 3D object 110, no matter how the 3D object 110 is moved with the platform 104, the 3D camera module 202 can always make the 3D object 110 be located at an intersection of a line determined by the center of the first image sensing unit 2022 and the 3D object 110 and a line determined by the center of the second image sensing unit 2024 and the 3D object 110. In addition, because a baseline between the first image sensing unit 2022 and the second image sensing unit 2024 can be varied with a distance existing between the first image sensing unit 2022 of the 3D camera module 202 and the 3D object 110, compared to the prior art, the 3D scan result TSR generated by the 3D camera module 202 can have less errors.

In addition, in another embodiment of the present invention, a baseline between the first image sensing unit 2022 and the second image sensing unit 2024 can be varied with a distance existing between the first image sensing unit 2022 of the 3D camera module 202 and the 3D object 110, and the first image sensing unit 2022 and the second image sensing unit 2024 can also be swung with a distance existing between the first image sensing unit 2022 of the 3D camera module 202 and the 3D object 110.

In addition, a diameter of each of molecules within the printing material layers 1102, 1104, 1106 is usually between 0.1-1 μm, the 3D scan result TSR generated by the image processing unit 2028 also has 0.1-1 μm resolution.

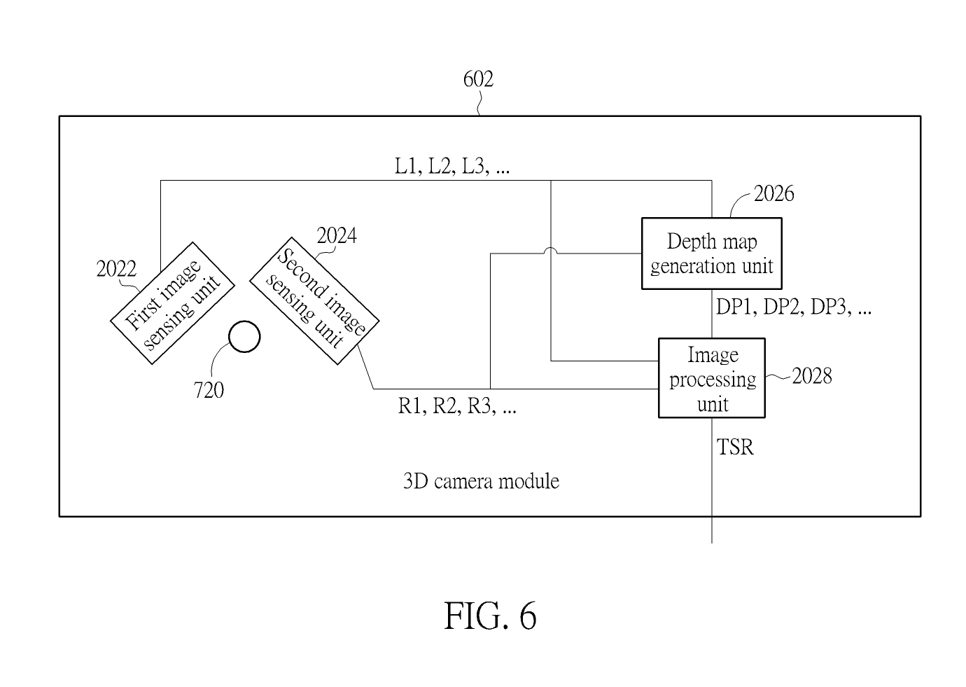

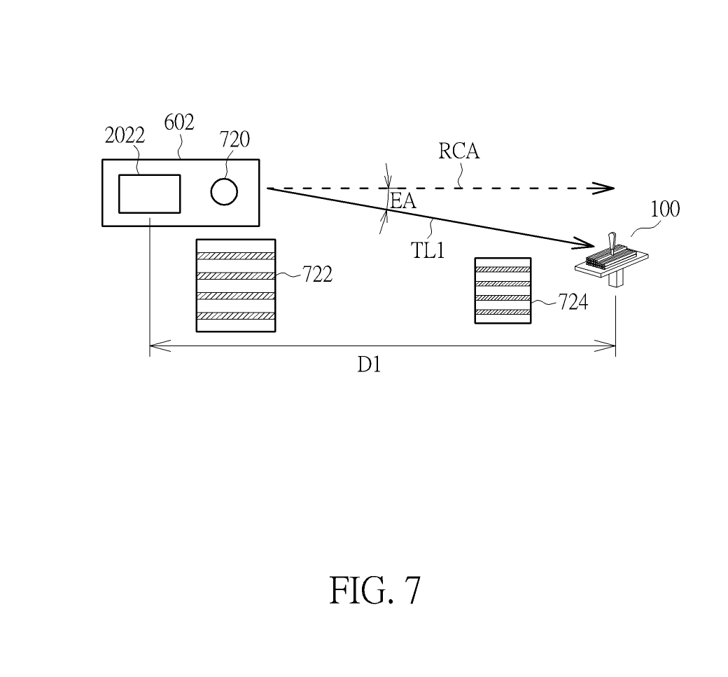

In addition, please refer to FIGS. 6, 7. FIG. 6 is a diagram illustrating a 3D camera module 602 according to another embodiment of the present invention, and FIG. 7 is a diagram illustrating relationships between an emitting angle of a light source 720, the distance D1 existing between the first image sensing unit 2022 of the 3D camera module 602 and the 3D object 110, and a ratio RA of a size of a predetermined light pattern 724 formed on a surface of the 3D object 110 to a size of a predetermined light pattern 722 emitted by the light source 720. As shown in FIG. 6, a difference between the 3D camera module 602 and the 3D camera module 202 is that the 3D camera module 602 further includes the light source 720, wherein the light source 720 can have different emitting angles. When the light source 720 emits the predetermined light pattern 722 (e.g. a strip pattern) to the 3D object 110, the first image sensing unit 2022 captures the first image L1 including the 3D object 110, and the second image sensing unit 2024 captures the second image R1 including the 3D object 110. But, the present invention is not limited to the predetermined light pattern 722 being a strip pattern. As shown in FIG. 7, an emitting angle EA of the light source 720 is determined by a line TL1 determined by the light source 720 and the 3D object 110 and a reference coordinate axis RCA, and when the distance D1 exists between the first image sensing unit 2022 of the 3D camera module 602 and the 3D object 110 (wherein FIG. 7 only shows the first image sensing unit 2022 and the light source 720 of the 3D camera module 602), the ratio RA can be determined by the size of the predetermined light pattern 724 formed on the surface of the 3D object 110 and the size of the predetermined light pattern 722 emitted by the light source 720, wherein the ratio RA corresponds the distance D1 and the emitting angle EA.

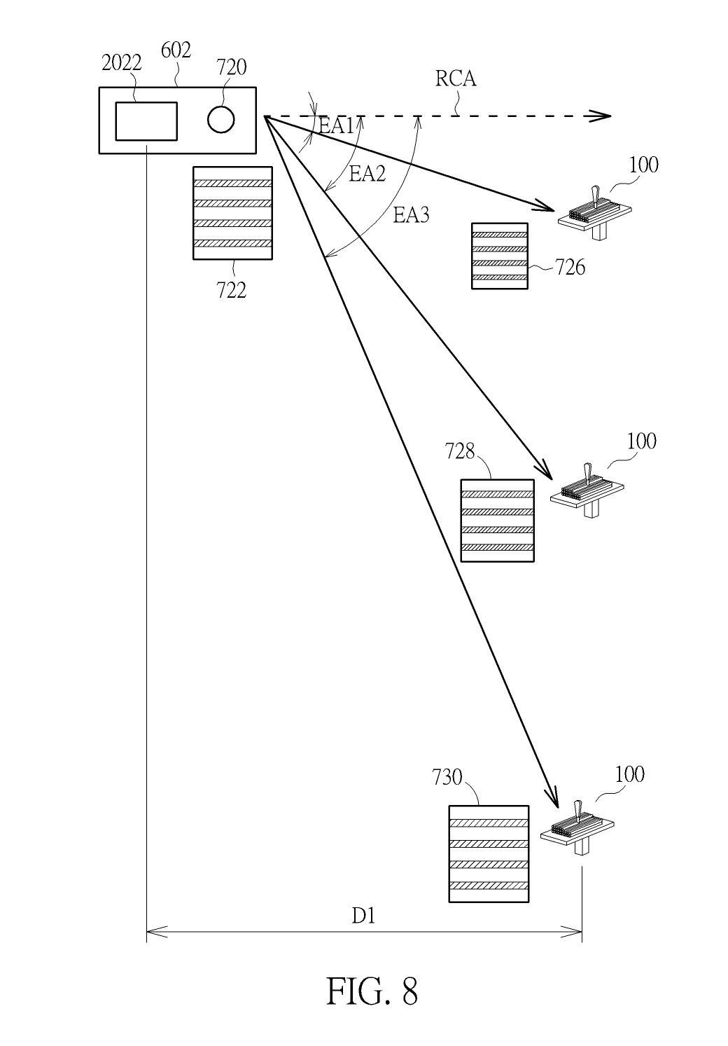

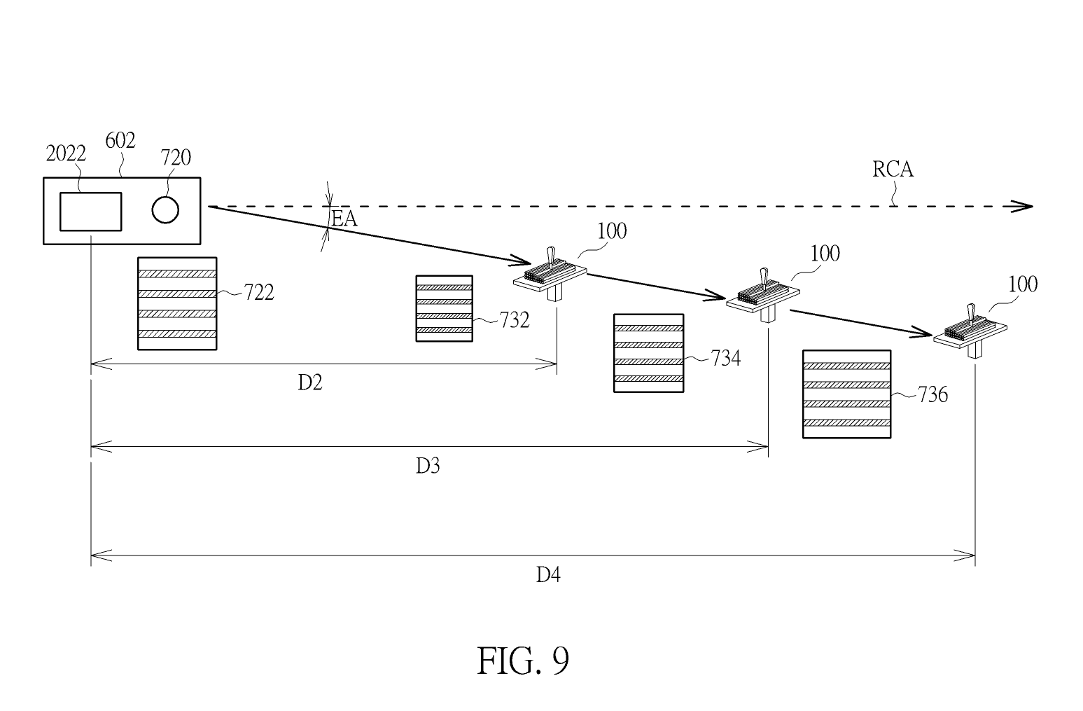

Please refer to FIGS. 8, 9. FIG. 8 is a diagram illustrating ratios determined by predetermined light patterns formed on the surface of the 3D object 110 and the size of the predetermined light pattern 722 emitted by the light source 720 being varied with different emitting angles of the light source 720 when the distance D1 exists between the first image sensing unit 2022 of the 3D camera module 602 and the 3D object 110, and the light source 720 has the different emitting angles, and FIG. 9 is a diagram illustrating ratios determined by predetermined light patterns formed on the surface of the 3D object 110 and the size of the predetermined light pattern 722 emitted by the light source 720 being varied with different distances existing between the first image sensing unit 2022 of the 3D camera module 602 and the 3D object 110 when different distances exist between the first image sensing unit 2022 of the 3D camera module 602 and the 3D object 110 and the light source 720 has the emitting angle EA. As shown in FIG. 8, when the distance D1 exists between the first image sensing unit 2022 of the 3D camera module 602 and the 3D object 110, and the light source 720 has an emitting angle EA1 (wherein FIG. 8 only shows the first image sensing unit 2022 and the light source 720 of the 3D camera module 602), a ratio RA1 can be determined by a size of a predetermined light pattern 726 formed on the surface of the 3D object 110 and the size of the predetermined light pattern 722 emitted by the light source 720; when the distance D1 exists between the first image sensing unit 2022 of the 3D camera module 602 and the 3D object 110 and the light source 720 has an emitting angle EA2, a ratio RA2 can be determined by a size of a predetermined light pattern 728 formed on the surface of the 3D object 110 and the size of the predetermined light pattern 722 emitted by the light source 720; and when the distance D1 exists between the first image sensing unit 2022 of the 3D camera module 602 and the 3D object 110 and the light source 720 has an emitting angle EA3, a ratio RA3 can be determined by a size of a predetermined light pattern 730 formed on the surface of the 3D object 110 and the size of the predetermined light pattern 722 emitted by the light source 720, wherein the ratio RA1, the ratio RA2, and the ratio RA3 are different each other. As shown in FIG. 9, when the light source 720 has the emitting angle EA and the distance D2 exists between the first image sensing unit 2022 of the 3D camera module 602 and the 3D object 110 (wherein FIG. 9 only shows the first image sensing unit 2022 and the light source 720 of the 3D camera module 602), a ratio RA4 can be determined by a size of a predetermined light pattern 732 formed on the surface of the 3D object 110 and the size of the predetermined light pattern 722 emitted by the light source 720; when the light source 720 has the emitting angle EA and the distance D3 exists between the first image sensing unit 2022 of the 3D camera module 602 and the 3D object 110, a ratio RA5 can be determined by a size of a predetermined light pattern 734 formed on the surface of the 3D object 110 and the size of the predetermined light pattern 722 emitted by the light source 720; and when the light source 720 has the emitting angle EA and the distance D4 exists between the first image sensing unit 2022 of the 3D camera module 602 and the 3D object 110, a ratio RA6 can be determined by a size of a predetermined light pattern 736 formed on the surface of the 3D object 110 and the size of the predetermined light pattern 722 emitted by the light source 720, wherein the ratio RA4, the ratio RA5, and the ratio RA6 are different each other. Because the 3D camera module 602 applied to the 3D printer 200 can utilize the light source 720 to emit the predetermined light pattern 722 to the 3D object 110, the 3D scan result TSR generated by the 3D camera module 602 can have higher resolution. In addition, subsequent operational principles of the 3D camera module 602 are the same as those of the 3D camera module 202, so further description thereof is omitted for simplicity. In addition, in another embodiment of the present invention, the light source 720 can emit laser light to the 3D object 110, and operational principles of the light source 720 emitting laser light are the same as those of the light source 720 emitting the predetermined light pattern 722, so further description thereof is omitted for simplicity.

In addition, as shown in FIG. 2, the 3D scan result TSR generated by the image processing unit 2028 of the 3D camera module 202 corresponding to the 3D object 110 is transmitted to the processing device 204 through a wired way (e.g. a universal serial bus (USB) or a mobile-industry-processor-interface (MIPI)). In addition, in another embodiment of the present invention, the 3D scan result TSR generated by the image processing unit 2028 corresponding to the 3D object 110 is transmitted to the processing device 204 through a wireless way (e.g. a Wireless Fidelity (WiFi), a wireless LAN (WLAN), a Zigbee (IEEE 802.15.4), a Bluetooth, a Wireless Wide Area Network (WWAN), a Global System for Mobile Communications (GSM), a General Packet Radio Service (GPRS), a third generation (3G), a fourth generation (4G), a fifth generation (5G), or an actor network theory+ (Ant+)).

During the printing process, after the processing device 204 receives the 3D scan result TSR corresponding to the 3D object 110, the processing device 204 can compare the track of the 3D relative motion with a right relative motion track stored in the processing device 204 according to the 3D scan result TSR corresponding to the 3D object 110. When an offset between the track of the 3D relative motion and the right relative motion track is less than the threshold, the processing device 204 generates an adjustment signal AS to the adjustment device 108. After the adjustment device 108 receives the adjustment signal AS, the adjustment device 108 can control the movement control device 106 to modify the track of the 3D relative motion to make the track of the 3D relative motion meet the right relative motion track according to the adjustment signal AS during the printing process. However, when the offset between the track of the 3D relative motion and the right relative motion track is greater than the threshold, the processing device 204 generates a termination signal TS to the adjustment device 108. After the adjustment device 108 receives the termination signal TS, the adjustment device 108 can control the movement control device 106 to make the 3D printer 200 terminate the printing process according to the termination signal TS.

In addition, in another embodiment of the 3D printer 200, the adjustment device 108 can control the print head 102 (meanwhile, the adjustment device 108 is coupled to the print head 102), or simultaneously control the print head 102 and the movement control device 106 (meanwhile, the adjustment device 108 is simultaneously coupled to the print head 102 and the movement control device 106) to modify the track of the 3D relative motion to make the track of the 3D relative motion meet the right relative motion track during the printing process, or make the 3D printer 100 terminate the printing process.

In addition, subsequent operational principles of the 3D printer 200 are the same as those of the 3D printer 100, so further description thereof is omitted for simplicity.

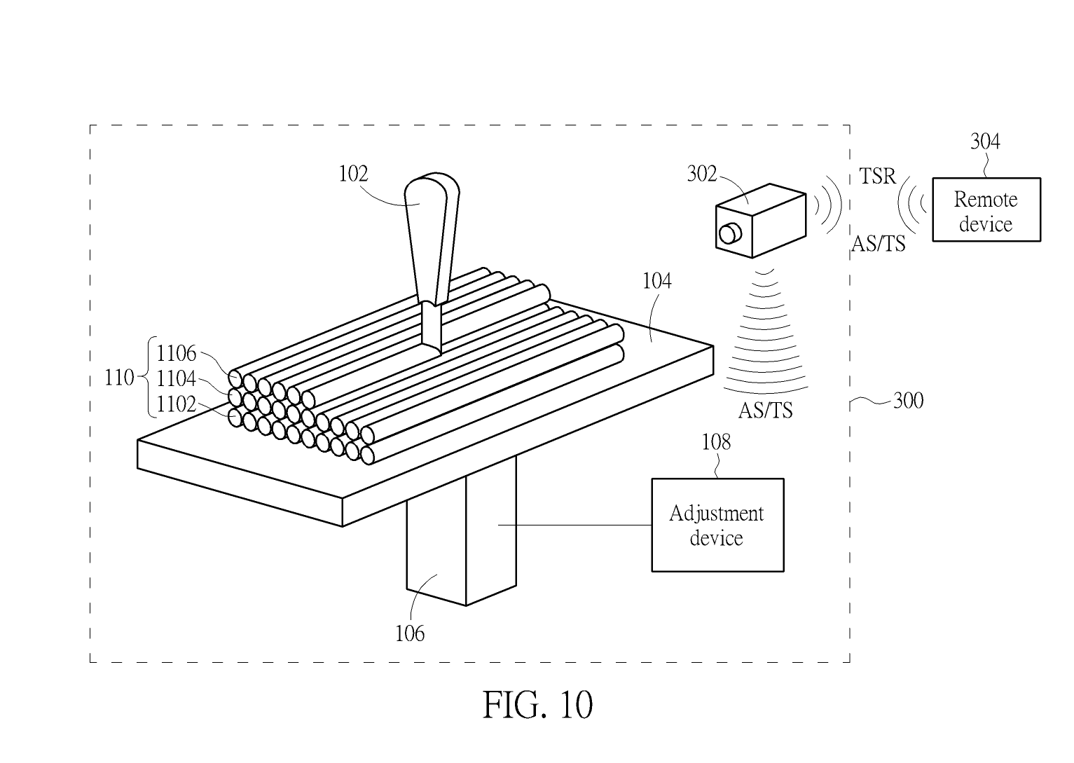

Please refer to FIG. 10. FIG. 10 is a diagram illustrating a 3D printer 300 with adjustment function according to a third embodiment of the present invention. As shown in FIG. 10, a difference between the 3D printer 300 and the 3D printer 100 is that the 3D printer 300 further includes a surveillance device 302. As shown in FIG. 10, the surveillance device 302 is coupled to the adjustment device 108 for generating the 3D scan result TSR corresponding to the 3D object 110 during the printing process and transmitting the 3D scan result TSR corresponding to the 3D object 110 to a remote device 304 (e.g. a personal computer, a tablet, or a smart phone), wherein the 3D scan result TSR corresponding to the 3D object 110 includes the information of the track of the 3D relative motion, and the surveillance device 302 transmits the 3D scan result TSR corresponding to the 3D object 110 to the remote device 304 through a wireless way (e.g. a Wireless Fidelity (WiFi), a wireless LAN (WLAN), a Zigbee (IEEE 802.15.4), a Bluetooth, a Wireless Wide Area Network (WWAN), a Global System for Mobile Communications (GSM), a General Packet Radio Service (GPRS), a third generation (3G), a fourth generation (4G), a fifth generation (5G), or an actor network theory+ (Ant+)). But, in another embodiment of the present invention, the surveillance device 302 transmits the 3D scan result TSR corresponding to the 3D object 110 to the remote device 304 through a wired way (e.g. a universal serial bus or a mobile-industry-processor-interface (MIPI)). But, in another embodiment of the present invention, the surveillance device 302 transmits the plurality of first images L1, L2, L3, . . . , the plurality of second images R1, R2, R3, . . . , and the plurality of the depth maps DP1, DP2, DP3, . . . corresponding to the 3D object 110 to the remote device 304. Then, the remote device 304 can generate the 3D scan result TSR corresponding to the 3D object 110 according to the plurality of first images L1, L2, L3, . . . , the plurality of second images R1, R2, R3, . . . , and the plurality of the depth maps DP1, DP2, DP3, . . .

When the offset between the track of the 3D relative motion and the right relative motion track is less than the threshold, the remote device 304 can generate the adjustment signal AS to the surveillance device 302, or a user makes the remote device 304 generate the adjustment signal AS to the surveillance device 302. After the surveillance device 302 receives the adjustment signal AS, the surveillance device 302 is further used for transmitting the adjustment signal AS to the adjustment device 108, and the adjustment device 108 can control the movement control device 106 to modify the track of the 3D relative motion to make the track of the 3D relative motion meet the right relative motion track according to the adjustment signal AS during the printing process.

In addition, when the offset between the track of the 3D relative motion and the right relative motion track is greater than the threshold, the remote device 304 can generate the termination signal TS to the surveillance device 302, or the user makes the remote device 304 generate the termination signal TS to the surveillance device 302. After the surveillance device 302 receives the termination signal TS, the surveillance device 302 is further used for transmitting the termination signal TS to the adjustment device 108, and the adjustment device 108 can control the movement control device 106 to make the 3D printer 300 terminate the printing process according to the termination signal TS. In addition, subsequent operational principles of the 3D printer 300 are the same as those of the 3D printer 100, so further description thereof is omitted for simplicity.

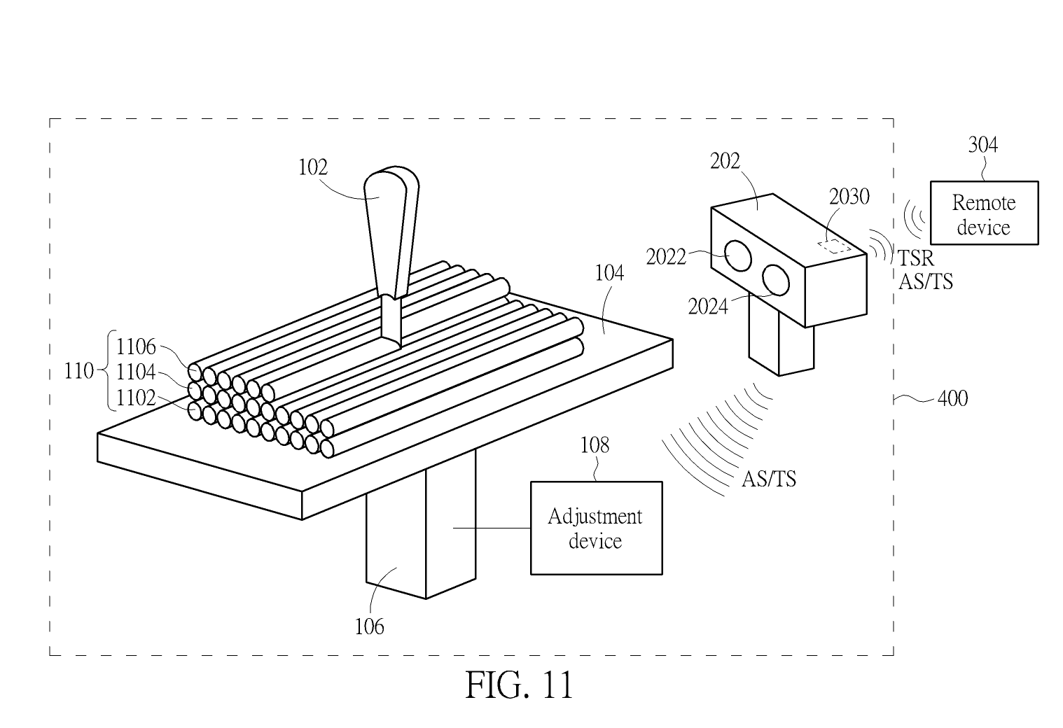

Please refer to FIG. 11. FIG. 11 is a diagram illustrating a 3D printer 400 with adjustment function according to a fourth embodiment of the present invention. As shown in FIG. 11, a difference between the 3D printer 400 and the 3D printer 200 is that a 3D camera module 202 of the 3D printer 400 further includes a surveillance device 2030, wherein operational principles of the surveillance device 2030 are the same as those of the surveillance device 302, so further description thereof is omitted for simplicity. In addition, operational principles of the 3D printer 400 are the same as those of the 3D printer 200, so further description thereof is also omitted for simplicity.

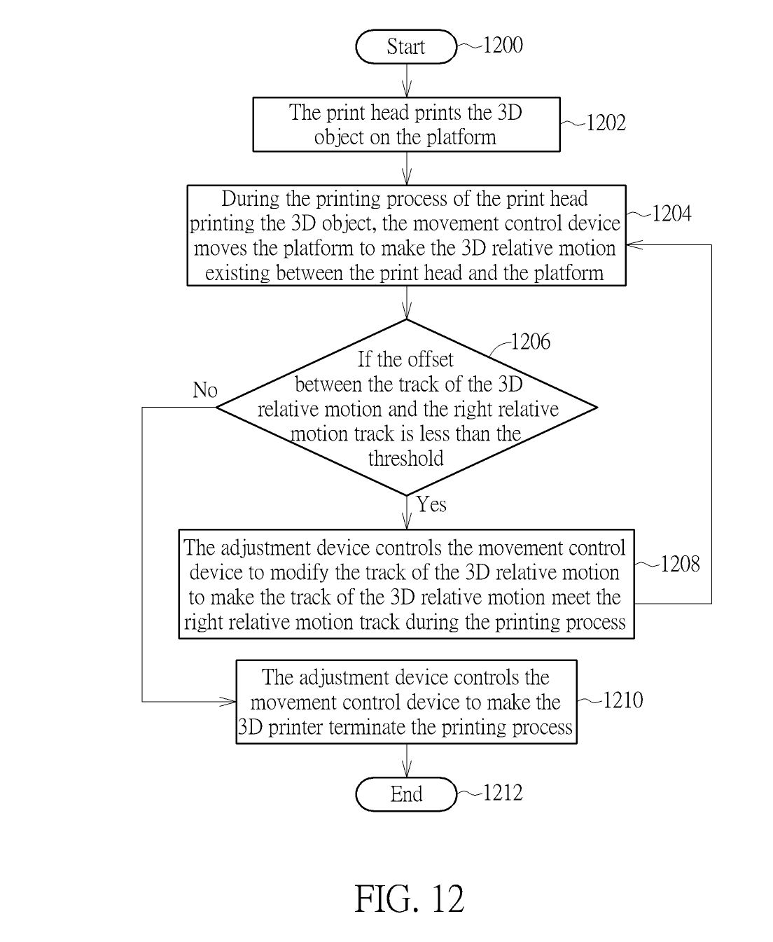

Please refer to FIGS. 1, 12. FIG. 12 is a flowchart illustrating an operation method of a 3D printer with adjustment function according to a fifth embodiment of the present invention. The operation method in FIG. 12 is illustrated using the 3D printer 100 in FIG. 1. Detailed steps are as follows:

Step 1200: Start.

Step 1202: The print head 102 prints the 3D object 110 on the platform 104.

Step 1204: During the printing process of the print head 102 printing the 3D object 110, the movement control device 106 moves the platform 104 to make the 3D relative motion existing between the print head 102 and the platform 104.

Step 1206: If the offset between the track of the 3D relative motion and the right relative motion track is less than the threshold; if yes, go to Step 1208; if no, go to Step 1210.

Step 1208: The adjustment device 108 controls the movement control device 106 to modify the track of the 3D relative motion to make the track of the 3D relative motion meet the right relative motion track during the printing process, go to Step 1204.

Step 1210: The adjustment device 108 controls the movement control device 106 to make the 3D printer 100 terminate the printing process, go to Step 1212.

Step 1212: End.

In Step 1204, because the movement control device 106 can move the platform 104 to make the 3D relative motion existing between the print head 102 and the platform 104 during the printing process of the print head 102 printing the 3D object 110 on the platform 104, the print head 102 can successively inject or generate the printing material layers 1102, 1104, 1106 forming the 3D object 110 layer by layer on the platform 104 during the printing process, wherein the 3D relative motion can be represented by the 3D Cartesian coordinate system or the 3D polar coordinate system. In Step 1208, if an error happens when the print head 102 just finishes the printing material layer 1104 and the movement control device 106 moves the platform 104 to the predetermined position to make the print head 102 prepare to inject or generate the printing material layers 1106 (e.g. the movement control device 106 should move the platform 104 toward the Z axis 1 mm away from a current position of the platform 104, but the movement control device 106 only moves the platform 104 toward the Z axis 0.6 mm away from the current position of the platform 104), meanwhile, the adjustment device 108 can control the movement control device 106 to modify the track of the 3D relative motion to make the track of the 3D relative motion meet the right relative motion track during the printing process because the offset (that is, 0.4 mm) between the track of the 3D relative motion and the right relative motion track is less than the threshold (e.g. 2 mm). In Step 1210, if the movement control device 106 should move the platform 104 toward the Z axis 1 mm away from the current position of the platform 104, but the movement control device 106 moves the platform 104 toward the Z axis 4 mm way from the current position of the platform 104, meanwhile, the adjustment device 108 can make the 3D printer 100 terminate the printing process because the offset (that is, 3 mm) between the track of the 3D relative motion and the right relative motion track is greater than the threshold (e.g. 2 mm).

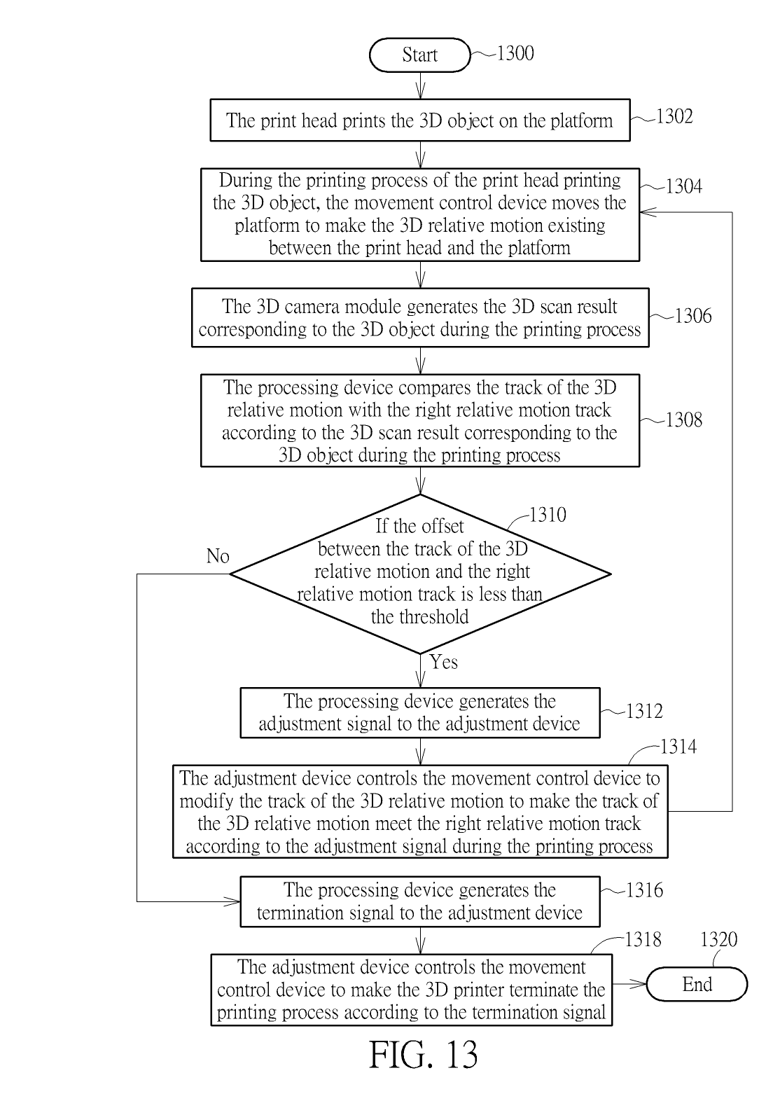

Please refer to FIGS. 2, 6-9, 13. FIG. 13 is a flowchart illustrating an operation method of a 3D printer with adjustment function according to a sixth embodiment of the present invention. The operation method in FIG. 13 is illustrated using the 3D printer 200 in FIG. 2. Detailed steps are as follows:

Step 1300: Start.

Step 1302: The print head 102 prints the 3D object 110 on the platform 104.

Step 1304: During the printing process of the print head 102 printing the 3D object 110, the movement control device 106 moves the platform 104 to make the 3D relative motion existing between the print head 102 and the platform 104.

Step 1306: The 3D camera module 202 generates the 3D scan result TSR corresponding to the 3D object 110 during the printing process.

Step 1308: The processing device 204 compares the track of the 3D relative motion with the right relative motion track according to the 3D scan result TSR corresponding to the 3D object 110 during the printing process.

Step 1310: If the offset between the track of the 3D relative motion and the right relative motion track is less than the threshold; if yes, go to Step 1312; if no, go to Step 1316.

Step 1312: The processing device 204 generates the adjustment signal AS to the adjustment device 108.

Step 1314: The adjustment device 108 controls the movement control device 106 to modify the track of the 3D relative motion to make the track of the 3D relative motion meet the right relative motion track according to the adjustment signal AS during the printing process, go to Step 1304.

Step 1316: The processing device 204 generates the termination signal TS to the adjustment device 108.

Step 1318: The adjustment device 108 controls the movement control device 106 to make the 3D printer 200 terminate the printing process according to the termination signal TS, go to Step 1320.

Step 1320: End.

Differences between the embodiment in FIG. 13 and the embodiment in FIG. 12 are that in Step 1306, as shown in FIG. 3, after the depth map generation unit 2026 generates the depth maps DP1, DP2, DP3, . . . corresponding to the 3D object 110, the image processing unit 2028 can generate and output the 3D scan result TSR corresponding to the 3D object 110 according to the plurality of first images L1, L2, L3, . . . , the plurality of second images R1, R2, R3, . . . , and the plurality of depth maps DP1, DP2, DP3, . . . , wherein the 3D scan result TSR corresponding to the 3D object 110 includes the information of the track of the 3D relative motion; in Step 1308, during the printing process, after the processing device 204 receives the 3D scan result TSR corresponding to the 3D object 110, the processing device 204 can compare the track of the 3D relative motion with the right relative motion track stored in the processing device 204 according to the 3D scan result TSR corresponding to the 3D object 110; in Step 1312, when the offset between the track of the 3D relative motion and the right relative motion track is less than the threshold, the processing device 204 generates the adjustment signal AS to the adjustment device 108; in Step 1314, after the adjustment device 108 receives the adjustment signal AS, the adjustment device 108 can control the movement control device 106 to modify the track of the 3D relative motion to make the track of the 3D relative motion meet the right relative motion track according to the adjustment signal AS during the printing process; in Step 1316, however, when the offset between the track of the 3D relative motion and the right relative motion track is greater than the threshold, the processing device 204 generates the termination signal TS to the adjustment device 108; and in Step 1318, after the adjustment device 108 receives the termination signal TS, the adjustment device 108 can control the movement control device 106 to make the 3D printer 200 terminate the printing process according to the termination signal TS.

In addition, as shown in FIGS. 6-9, because the 3D camera module 602 applied to the 3D printer 200 can utilize the light source 720 to emit the predetermined light pattern 722 to the 3D object 110, the 3D scan result TSR generated by the 3D camera module 602 can have higher resolution. In addition, in another embodiment of the present invention, the light source 720 can emit laser light to the 3D object 110, and operational principles of the light source 720 emitting laser light are the same as those of the light source 720 emitting the predetermined light pattern 722, so further description thereof is omitted for simplicity. In addition, subsequent operational principles of the embodiment in FIG. 13 are the same as those of the embodiment in FIG. 12, so further description thereof is omitted for simplicity.

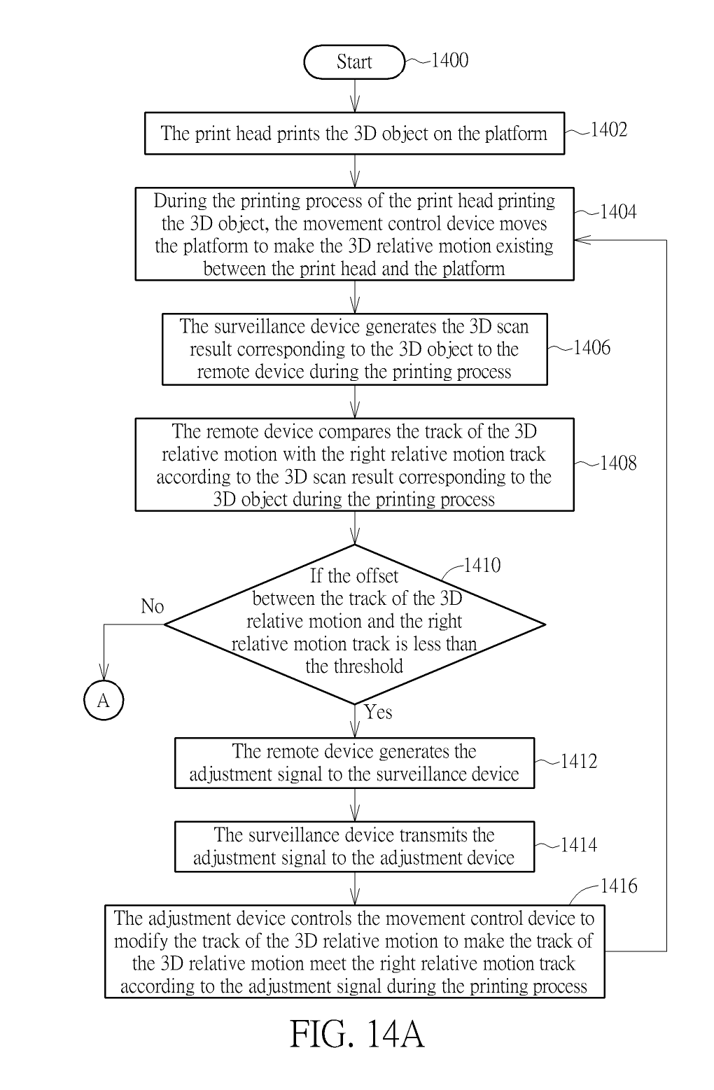

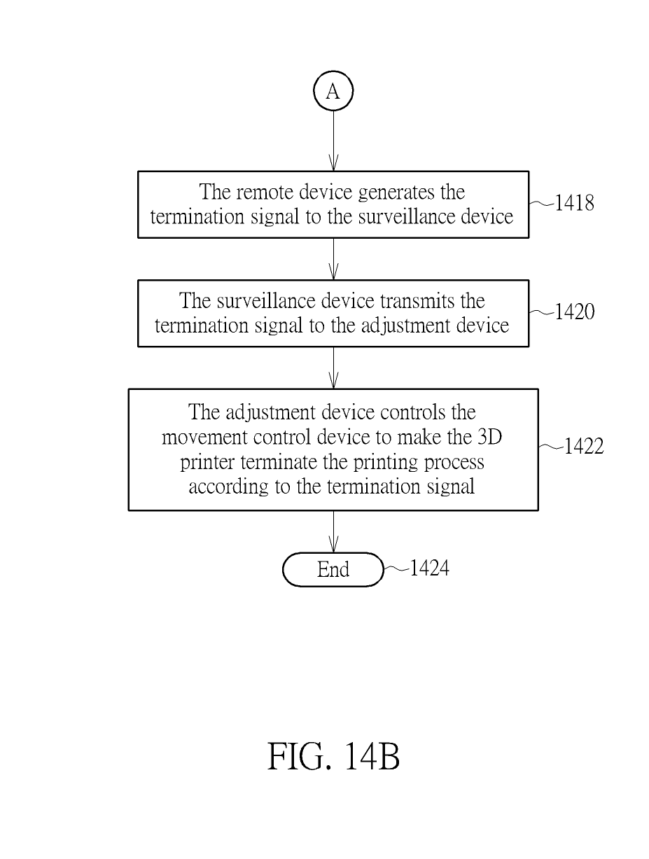

Please refer to FIGS. 10, 14A, 14B. FIGS. 14A, 14B are flowcharts illustrating an operation method of a 3D printer with adjustment function according to a seventh embodiment of the present invention. The operation method in FIGS. 14A, 14B is illustrated using the 3D printer 300 in FIG. 10. Detailed steps are as follows:

Step 1400: Start.

Step 1402: The print head 102 prints the 3D object 110 on the platform 104.

Step 1404: During the printing process of the print head 102 printing the 3D object 110, the movement control device 106 moves the platform 104 to make the 3D relative motion existing between the print head 102 and the platform 104.

Step 1406: The surveillance device 302 generates the 3D scan result TSR corresponding to the 3D object 110 to the remote device 304 during the printing process.

Step 1408: The remote device 304 compares the track of the 3D relative motion with the right relative motion track according to the 3D scan result TSR corresponding to the 3D object 110 during the printing process.

Step 1410: If the offset between the track of the 3D relative motion and the right relative motion track is less than the threshold; if yes, go to Step 1412; if no, go to Step 1418.

Step 1412: The remote device 304 generates the adjustment signal AS to the surveillance device 302.

Step 1414: The surveillance device 302 transmits the adjustment signal AS to the adjustment device 108.

Step 1416: The adjustment device 108 controls the movement control device 106 to modify the track of the 3D relative motion to make the track of the 3D relative motion meet the right relative motion track according to the adjustment signal AS during the printing process, go to Step 1404.

Step 1418: The remote device 304 generates the termination signal TS to the surveillance device 302.

Step 1420: The surveillance device 302 transmits the termination signal TS to the adjustment device 108.

Step 1422: The adjustment device 108 controls the movement control device 106 to make the 3D printer 300 terminate the printing process according to the termination signal TS, go to Step 1424.

Step 1424: End.

Differences between the embodiment in FIGS. 14A, 14B and the embodiment in FIG. 13 are that in Step 1406, the surveillance device 302 generates the 3D scan result TSR corresponding to the 3D object 110 during the printing process and transmitting the 3D scan result TSR corresponding to the 3D object 110 to the remote device 304 (e.g. a personal computer, a tablet, or a smart phone), wherein the 3D scan result TSR corresponding to the 3D object 110 includes the information of the track of the 3D relative motion. However, in another embodiment of the present invention, the surveillance device 302 transmits the plurality of first images L1, L2, L3, . . . , the plurality of second images R1, R2, R3, . . . , and the plurality of the depth maps DP1, DP2, DP3, . . . corresponding to the 3D object 110 to the remote device 304. Then, the remote device 304 can generate the 3D scan result TSR corresponding to the 3D object 110 according to the plurality of first images L1, L2, L3, . . . , the plurality of second images R1, R2, R3, . . . , and the plurality of the depth maps DP1, DP2, DP3, . . .

In Step 1412, when the offset between the track of the 3D relative motion and the right relative motion track is less than the threshold, the remote device 304 can generate the adjustment signal AS to the surveillance device 302, or the user makes the remote device 304 generate the adjustment signal AS to the surveillance device 302; in Step 1414 and Step 1416, after the surveillance device 302 receives the adjustment signal AS, the surveillance device 302 can further transmit the adjustment signal AS to the adjustment device 108, and the adjustment device 108 can control the movement control device 106 to modify the track of the 3D relative motion to make the track of the 3D relative motion meet the right relative motion track according to the adjustment signal AS during the printing process; in Step 1418, when the offset between the track of the 3D relative motion and the right relative motion track is greater than the threshold, the remote device 304 can generate the termination signal TS to the surveillance device 302, or the user makes the remote device 304 generate the termination signal TS to the surveillance device 302; in Step 1420 and Step 1422, after the surveillance device 302 receives the termination signal TS, the surveillance device 302 can further transmit the termination signal TS to the adjustment device 108, and the adjustment device 108 can control the movement control device 106 to make the 3D printer 300 terminate the printing process according to the termination signal TS. In addition, subsequent operational principles of the embodiment in FIGS. 14A, 14B are the same as those of the embodiment in FIG. 13, so further description thereof is omitted for simplicity.

To sum up, the 3D printer and the operation method thereof utilize the adjustment device or the processing device to compare the track of the 3D relative motion between the print head and the platform with the right relative motion track during the printing process of the print head printing the 3D object, wherein when the offset between the track of the 3D relative motion and the right relative motion track is less than the threshold, the adjustment device controls the print head or the movement control device to make the track of the 3D relative motion meet the right relative motion track during the printing process, and when the offset between the track of the 3D relative motion and the right relative motion track is greater than the threshold, the adjustment device controls the print head or the movement control device to make the 3D printer terminate the printing process. Therefore, compared to the prior art, because the 3D printer has the adjustment function, the present invention can real time utilize the adjustment device to control the print head or the movement control device to make the track of the 3D relative motion meet the right relative motion track during the printing process when there is any mistake happens (e.g. shift or dislocation of the movement control device, unwanted movement or pull of the semi-finished 3D object on the platform, and so on). Therefore, the present invention can increase a printing speed of the 3D printer and decrease time consumption during the printing process.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A three-dimensional (3D) printer with adjustment function, comprising:
a print head;
a platform;
a movement control device coupled to the platform, wherein the movement control device moves the platform to make a 3D relative motion existing between the platform and the print head during a printing process of the print head printing a 3D object on the platform; and
an adjustment device controlling the print head or the movement control device to make a track of the 3D relative motion meet a right relative motion track during the printing process, or make the 3D printer terminate the printing process.

2. The 3D printer of claim 1, wherein the 3D relative motion is represented by a 3D Cartesian coordinate system.

3. The 3D printer of claim 1, wherein the 3D relative motion is represented by a 3D polar coordinate system.

4. The 3D printer of claim 1, further comprising:
a 3D camera module generating a 3D scan result corresponding to the 3D object during the printing process, wherein the 3D scan result corresponding to the 3D object comprises an information of the track of the 3D relative motion;
a processing device coupled to the 3D camera module, wherein the processing device stores the right relative motion track, and compares the track of the 3D relative motion with the right relative motion track according to the 3D scan result corresponding to the 3D object during the printing process, wherein when an offset between the track of the 3D relative motion and the right relative motion track is less than a threshold, the processing device generates an adjustment signal to the adjustment device, and when the offset between the track of the 3D relative motion and the right relative motion track is greater than the threshold, the processing device generates a termination signal to the adjustment device.

5. The 3D printer of claim 4, wherein the adjustment device controls the print head or the movement control device to make the track of the 3D relative motion meet the right relative motion track according to the adjustment signal during the printing process.

6. The 3D printer of claim 4, wherein the adjustment device controls the print head or the movement control device to make the 3D printer terminate the printing process according to the termination signal.

7. The 3D printer of claim 1, further comprising:
a surveillance device coupled to the adjustment device for generating a 3D scan result corresponding to the 3D object during the printing process and transmitting the 3D scan result corresponding to the 3D object to a remote device, wherein the 3D scan result corresponding to the 3D object comprises an information of the track of the 3D relative motion;
wherein when an offset between the track of the 3D relative motion and the right relative motion track is less than a threshold, the remote device generates an adjustment signal to the surveillance device, and when the offset between the track of the 3D relative motion and the right relative motion track is greater than the threshold, the remote device generates a termination signal to the surveillance device.

8. The 3D printer of claim 7, wherein the surveillance device further transmits the adjustment signal to the adjustment device, and the adjustment device controls the print head or the movement control device to make the track of the 3D relative motion meet the right relative motion track according to the adjustment signal during the printing process.

9. The 3D printer of claim 7, wherein the surveillance device further transmits the termination signal to the adjustment device, and the adjustment device controls the print head or the movement control device to make the 3D printer terminate the printing process according to the termination signal.

10. An operation method of a 3D printer with adjustment function, wherein the 3D printer comprises a print head, a platform, a movement control device, and an adjustment device, the operation method comprising:
the print head printing a 3D object on the platform;
the movement control device moving the platform to make a 3D relative motion existing between the platform and the print head during a printing process of the print head printing the 3D object; and
the adjustment device controlling the print head or the movement control device to make a track of the 3D relative motion meet a right relative motion track during the printing process, or make the 3D printer terminate the printing process.

11. The operation method of claim 10, wherein the 3D relative motion is represented by a 3D Cartesian coordinate system.

12. The operation method of claim 10, wherein the 3D relative motion is represented by a 3D polar coordinate system.

13. The operation method of claim 10, wherein the adjustment device controlling the print head or the movement control device to make the track of the 3D relative motion meet the right relative motion track during the printing process comprises:
a 3D camera module further comprised in the 3D printer generating a 3D scan result corresponding to the 3D object during the printing process, wherein the 3D scan result corresponding to the 3D object comprises an information of the track of the 3D relative motion;
a processing device further comprised in the 3D printer comparing the track of the 3D relative motion with the right relative motion track according to the 3D scan result corresponding to the 3D object during the printing process;
the processing device generating an adjustment signal to the adjustment device when an offset between the track of the 3D relative motion and the right relative motion track is less than a threshold; and
the adjustment device controlling the print head or the movement control device to make the track of the 3D relative motion meet the right relative motion track according to the adjustment signal during the printing process.

14. The operation method of claim 10, wherein the adjustment device controlling the print head or the movement control device to make the 3D printer terminate the printing process comprises:
a 3D camera module further comprised in the 3D printer generating a 3D scan result corresponding to the 3D object during the printing process, wherein 3D scan result corresponding to the 3D object comprises an information of the track of the 3D relative motion;
a processing device further comprised in the 3D printer comparing the track of the 3D relative motion with the right relative motion track according to the 3D scan result corresponding to the 3D object during the printing process;
the processing device generating a termination signal to the adjustment device when an offset between the track of the 3D relative motion and the right relative motion track is greater than a threshold; and
the adjustment device controlling the print head or the movement control device to make the 3D printer terminate the printing process according to the termination signal.

15. The operation method of claim 10, wherein the adjustment device controlling the print head or the movement control device to make the track of the 3D relative motion meet the right relative motion track during the printing process comprises:
a surveillance device further comprised in the 3D printer generating and transmitting a 3D scan result corresponding to the 3D object to a remote device during the printing process, wherein the 3D scan result corresponding to the 3D object comprises an information of the track of the 3D relative motion;
the remote device generating an adjustment signal to the surveillance device when an offset between the track of the 3D relative motion and the right relative motion track is less than a threshold;
the surveillance device transmitting the adjustment signal to the adjustment device; and
the adjustment device controlling the print head or the movement control device to make the track of the 3D relative motion meet the right relative motion track according to the adjustment signal during the printing process according to the adjustment signal.

16. The operation method of claim 10, wherein the adjustment device controlling the print head or the movement control device to make the 3D printer terminate the printing process comprises:
a surveillance device further comprised in the 3D printer generating and transmitting a 3D scan result corresponding to the 3D object to a remote device during the printing process, wherein the 3D scan result corresponding to the 3D object comprises an information of the track of the 3D relative motion;
the remote device generating a termination signal to the surveillance device when an offset between the track of the 3D relative motion and the right relative motion track is greater than a threshold;
the surveillance device transmitting the termination signal to the adjustment device; and
the adjustment device controlling the print head or the movement control device to make the 3D printer terminate the printing process according to the termination signal.

17. A 3D printer, comprising:
a print head;
a platform;
a movement control device coupled to the platform or the print head, wherein the movement control device controls to generate a track of a relative motion between the platform and the print head to make the print head print a 3D object on the platform; and
an adjustment device comparing the track of the relative motion with a default print track to optionally adjust the track of the relative motion, or make the 3D printer terminate to print the 3D object.

18. The 3D printer of claim 17, further comprising:
a surveillance device coupled to the adjustment device for generating a scan result corresponding to the 3D object during a process of the print head printing the 3D object, wherein the scan result corresponding to the 3D object comprises an information of the track of the relative motion;
wherein when an offset between the track of the relative motion and the default print track is less than a threshold, the adjustment device adjusts the track of the relative motion, and when the offset between the track of the relative motion and the default print track is greater than the threshold, the adjustment device makes the 3D printer terminate to print the 3D object.
